(19) United States
(12) Patent Application Publication
(10) Pub. No.: US 2014/0337265 A1
(43) Pub. Date: Nov. 13, 2014

(54) CONTROLLABILITY CHECKING SYSTEMS AND METHODS

(71) Applicant: NVIDIA CORPORATION, Santa Clara, CA (US)

(72) Inventors: Tamir HEYMAN, Portland, OR (US); Dan SMITH, Los Gatos, CA (US); Lance LEONG, San Jose, CA (US); Husam ABU-HAIMED, Sunnyvale, CA (US); Yogesh MAHAJAN, Menlo Park, CA (US)

(73) Assignee: NVIDIA Corporation, Santa Clara, CA (US)

(21) Appl. No.: 13/890,180

(22) Filed: May 8, 2013

(51) Int. Cl. G06N 5/02

(52) U.S. Cl. CPC G06N 5/02
USPC 706/46

(57) ABSTRACT

An intelligent controllability check process can intelligently examine if enumeration of some possible values for a set of control signal inputs can be avoided (e.g., resulting in less than all possible values being enumerated, etc.). A modified intelligent QBF controllability check can be utilized, including a modified intelligent QBF solver. The process can include a formal controllability check with an extensive or exhaustive consideration of possible value assignments while avoiding enumeration of some possibilities. The formal controllability check can examine if a proof establishes a conclusion regarding assignment values. The proof can be utilized in determining possible results including: (1) a conclusion that signals provide controllability; (2) a conclusion that signals do not provide controllability; or (3) can not reach a conclusion one way or other if signals do or do not provide controllability. Results (e.g., SAT, UNSAT, etc.) of the QBF controllability check can be verified.

### FIELD OF THE INVENTION

The present invention relates to power control systems. In particular, the present invention relates to systems and methods for power management controllability checking.

### BACKGROUND OF THE INVENTION

Electronic systems and devices (e.g., very large scale integrated chips, central processing units, graphics processing units, etc.) have made a significant contribution towards the advancement of modern society and are utilized in a number of applications to achieve advantageous results. Numerous electronic technologies such as digital computers, calculators, audio devices, video equipment, and telephone systems have facilitated increased productivity and reduced costs in analyzing and communicating data in most areas of business, science, education and entertainment. These electronic technologies often involve attempts at power management control in very large and complex hardware designs. However, traditional attempts at power management control checking typically lack sufficient capacity and capability for rapid power management control checking of very large hardware design applications. The lack of rapid responses in conventional controllability check approaches often results in inefficient occupation of resources.

The ability to control power usage and supply in very large hardware design applications is very important and power controllability can often have a significant impact on performance and power consumption efficiency. Power management controllability can be particularly critical in very large hardware design applications involving limited power supplies (e.g., mobile devices, battery powered devices, etc.). In some conventional approaches, regions of a device or system are turned off (e.g., when it's determined that they're not being used, etc.) and this can result in reduction in power expenditure that might otherwise occur (e.g., due to power leakage, etc.). In many applications, relatively small components (e.g., power gate, switch, transistors, etc.) are used to allow or prevent power consumption by various components of a device or system. The relatively small components are often activated or deactivated by a dedicated signal (e.g., a clamp signal, sleep signal, etc.) that is output by a power control component. The relatively small control components can control various components or blocks of components and power controllability checks can be applied to components of various granularity (e.g., individual components of a chip, blocks of components in a chip, etc.).

In general, controllability is the ability to change a system state by manipulating certain input signals. Controllability is typically a property of a control system's output resulting in a particular value in response to a specific input configuration. Power management controllability checks typically attempt to ascertain whether a set of inputs can control an output signal state. In one example, an examination is performed to ascertain if a sleep control signal or power clamp signal is active at a specific assignment of inputs and inactive at another input value configuration. Some conventional controllability checks examine if a set of power control signals can set and reset a power gate signal regardless of other inputs.

Traditional controllability checks typically involve logic equations that define a control component under analysis and resulting output signal s, signal values applied to a set of control signal inputs C on the control input terminals of the control component under analysis, and a target value v that is a target value for s. Values are assigned or applied to the set of control signal inputs C and the logic equations solved (e.g., simulating propagation of the values through the control component under analysis, etc.). If the resulting signal s gets the target value v after applying the assigned values to the set of control signal inputs C and solving the equations, a requested assignment of values to the control signal inputs C that provides controllability is considered successfully found or identified.

In a very large hardware design there are usually numerous inputs and identifying which of the numerous input signals impact power controllability is important for performing power control and power management. The large number of inputs makes checking which of them impact power management controllability very complex and difficult. In a controllability check there are typically multiple sets of values applied to the control signal inputs C. Traditional approaches typically include enumeration of all possible values that can be applied to the control signal inputs C. In many traditional checking controllability approaches, attempts are made to look for an assignment of values to control signal inputs C out of 2^{|C|} possibilities such that s gets the value v regardless of the other inputs. In situations where the set of control signal inputs C is more than a very small set, the enumeration of each possible values results in checking a large number of possibilities which typically consumes considerable processing resources and time. Two alternative conventional approaches for power controllability checking are X propagation controllability checking and constant propagation controllability checking. Each of these approaches involve enumeration of all possible input values and typically consume considerable processing resources and time in very large hardware design applications.

Traditional X propagation controllability checking is based on a three value simulation (0,1,X). For each possible assignment of values to the set of control signal inputs C (e.g., 0 and 1 on each bit input of C), the rest of the input terminals are set to X. Then, values are “propagated” or applied to the corresponding equation and the signal s is evaluated. For example, one version of conventional power gating involves an AND logic gate with two inputs. If one input is set to 0 and the other input is set to X, the output of the AND gate evaluates to constant 0. In one example, a signal s1 with value X and a signal s1 negated or inverted are the inputs to an AND gate. An X propagation method will evaluate this gate to be X while other, more precise evaluation will realize it is a constant zero. Even though the X propagation technique of assignment evaluation may be fast enough for a very small size set of control signal inputs C, it still has potential problems. One problem is it may be too conservative (results in false negatives) that may lead to skipping of a good assignment. Furthermore, even thought the X propagation typically does not require expression optimization, it still involves enumeration of all possible values to the set of control signal inputs C and becomes exponentially slower as the size of the set of control signal inputs C increases.

In conventional attempts at constant propagation controllability checking, all the possible multiple sets of values of control signal inputs C are enumerated and each set of values in control signal inputs C are assigned to the inputs. Then, the expression of output signal s can be optimized (e.g., using expression optimization like constant propagation, redundancy removal, de-Morgan's rules, etc.) and the constants are propagated. If output signal s reduces to a constant value and the value is a target value v the check is passed. This conventional constant propagation controllability checking approach is often more accurate than the conventional X propagation controllability checking approach. For example, a conventional constant propagation controllability checking approach can realize that the above AND gate is a constant zero. However, this method is usually much slower and typically still too conservative. For example, in complicated cases it may get an expression that is too complex to realize it is a constant, which can lead to skipping a good assignment.

### SUMMARY

Presented systems and methods can facilitate controllability checking. In one embodiment, an intelligent controllability check process examines if a conclusion regarding a controllability check can be established while avoiding enumerating some possible values for a set of control signal inputs. The reduction or avoidance of enumerating some values of a set of possible control signal inputs (e.g., C, etc.) conserves resources (e.g., processing time, processing power, etc.) utilized to perform controllability checking. In one embodiment, an intelligent controllability check process includes a formal controllability check that can include an extensive or exhaustive consideration of possible value assignments while avoiding enumeration of some possibilities. In one exemplary implementation, the formal controllability check examines if a proof establishes a conclusion regarding assignment values (e.g., prove an input value exists that causes a output target value, prove no such input value exists, etc.). A modified intelligent controllability check process can utilize the proof in determining possible results including: (1) a conclusion that signals provide controllability; (2) a conclusion that signals do not provide controllability; or (3) can not reach a conclusion one way or other if signals do or do not provide controllability.

In one embodiment, a modified intelligent Quantified Boolean Formula (QBF) controllability check is utilized including a modified intelligent QBF solver. In one embodiment, the controllability check is looking for an assignment of values to a set of control input signals that result in the value of an output signal being a particular value regardless of the values of other inputs. The intelligent controllability process can include: performing an initialization process, including translating values in a controllability environment format into a solver environment format; performing modified intelligent QBF solving; and returning the results of the solving. The intelligent controllability process can include: mapping between each solver environment format value and corresponding control component under analysis interface values; and maintaining a list of the mapping.

It is appreciated that the presented approach can be readily implemented in a variety of configurations. The intelligent controllability checking can include multiple levels or techniques of controllability checking. The different levels of controllability checking can be used for various reasons (e.g., if one technique fails to reach a conclusion, utilizing a second technique as a verification of first technique results, etc.). In one embodiment, the intelligent controllability process includes: performing a first controllability checking technique (e.g., a modified intelligent QBF controllability checking, etc.) and performing a second controllability checking technique (e.g., a constant propagation controllability checking, etc.). The second controllability checking technique can be performed on the results of the first technique for verification. The second controllability checking technique can be performed if the first controllability checking technique fails to conclude the signals are controllable. In one exemplary implementation, if a conclusion regarding controllability can not be established with less than all possible values of a set of control signal inputs being enumerated, an option to enumerate all possible values can be implemented.

### DESCRIPTION OF THE DRAWINGS

The accompanying drawings, which are incorporated in and form a part of this specification, illustrate embodiments of the invention by way of example and not by way of limitation. The drawings referred to in this specification should be understood as not being drawn to scale except if specifically noted.

FIG. 1 is a flow chart of an exemplary intelligent controllability check method in accordance with one embodiment of the present invention.

FIG. 2 is a block diagram of an exemplary of intelligent controllability check environment in accordance with one embodiment of the present invention.

FIG. 3 is a block diagram of assignment scenarios for the set of control signal inputs C in accordance with one embodiment of the present invention.

FIG. 4 is a flow chart of an exemplary intelligent controllability check process in accordance with one embodiment of the present invention.

FIG. 5 is a block diagram of an exemplary controllability test system including translations and mapping in accordance with one embodiment of the present invention.

FIG. 6 is a block diagram of an exemplary intelligent QBF controllability checking system including translations and mapping in accordance with one embodiment of the present invention.

FIG. 7 is a flow chart of an exemplary intelligent QBF controllability check method in accordance with one embodiment of the present invention.

FIG. 8 is a flow chart of an exemplary intelligent QBF controllability check method including verification in accordance with one embodiment of the present invention.

FIG. 9 is a flow chart of an exemplary controllability check method including a second controllability check process in accordance with one embodiment of the present invention.

FIG. 10 is a flow chart of an exemplary controllability check method including a constant propagation controllability check process if a modified intelligent QBF controllability check process can not reach a conclusion one way or other if signals are controllable in accordance with one embodiment of the present invention.

FIG. 11 is a flow chart of an exemplary controllability check method including a modified constant propagation controllability check process and a modified intelligent QBF controllability check process if the modified constant propagation controllability check process can not reach a conclusion one way or other if signals do or do not provide controllability in accordance with one embodiment of the present invention.

FIG. 12 is a flow chart of an exemplary controllability check method including a verification of the results of the modified intelligent QBF controllability check process when a modified intelligent QBF controllability check process results in a conclusion that the signals are controllable; and a constant propagation controllability check process if the modified intelligent QBF controllability check process results in a conclusion the signals do not provide controllability, or can not reach a conclusion one way or other if signals do or do not provide controllability in accordance with one embodiment of the present invention.

FIG. 13 is a table or graph of exemplary run time versus complexity results in accordance with one embodiment of the present invention.

FIG. 14 is a block diagram of a exemplary computer system, one embodiment of a computer system upon which embodiments of the present invention can be implemented.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and control component under analysis have not been described in detail as not to unnecessarily obscure aspects of the present invention.

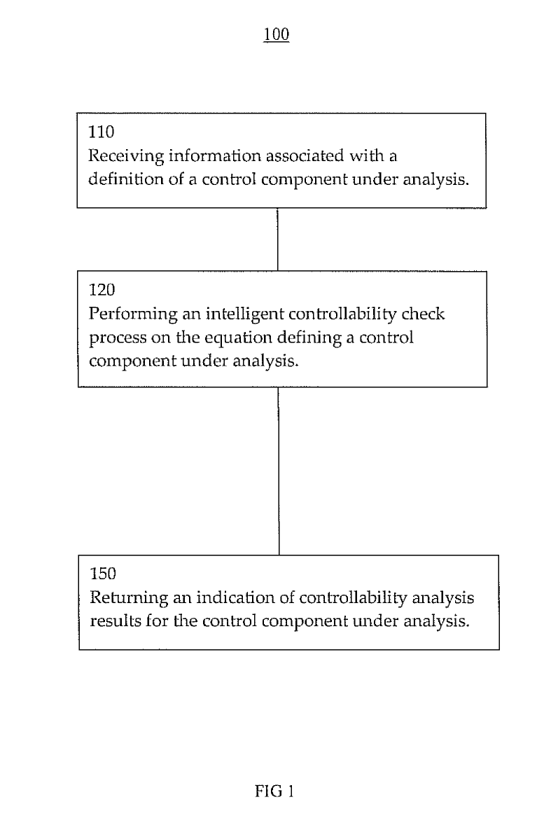

Presented systems and methods can facilitate efficient intelligent controllability checking. FIG. 1 is a flow chart of an exemplary intelligent controllability check method 100 in accordance with one embodiment of the present invention. In one embodiment, intelligent controllability check method 100 is implemented in very large hardware design applications. In one exemplary implementation, the intelligent controllability check process intelligently checks if enumeration of some possible assignment values for a set of control signal inputs can be avoided and if a conclusion regarding controllability can be established. If a conclusion regarding controllability can not be established with less than all possible assignment values of a set of control signal inputs being enumerated, an option to enumerate and consider all possible values can be implemented.

In block 110, information associated with a definition of a control component under analysis (e.g., hardware description, logic expressions, etc.) is received. In one embodiment, an equation defining a control component under analysis, a set of control signal inputs C that are inputs to a control component under analysis, and a target value v for an output signal s of the control component under analysis are received. It is appreciated the control component under analysis can be a power control component (e.g., power gate, switch, etc.).

In block 120, an intelligent controllability check process is performed based upon the information received in block 110. In one embodiment, the intelligent controllability process examines if assignments of values to control signal inputs C cause output signal s to be the target value of v. In one exemplary implementation, the intelligent controllability check process examines if enumeration of some possible value assignments for a set of control signal inputs (e.g., C, etc.) can be avoided.

In one embodiment, a modified intelligent controllability check process includes a formal controllability check. A formal controllability check approach can include an extensive or exhaustive consideration of possible value assignments while avoiding enumeration of some possibilities. In one exemplary implementation, a modified intelligent controllability check process enumeration avoidance results in less than all possible values being enumerated and applied to the inputs of the control component under analysis or inputs to the equation defining the control component under analysis that would otherwise occur in a traditional constant propagation approach. In one embodiment, a formal controllability check approach does not use random analysis (e.g., random selection of possible values, etc,). In one exemplary implementation, the formal controllability check examines if a proof establishes a conclusion regarding assignment values (e.g., prove an input value exists that cause a output target value, prove no such input value exists, etc.). A modified intelligent controllability check process can utilize the proof in determining possible results including: (1) a conclusion that signals provide controllability; (2) a conclusion that signals do not provide controllability; or (3) can not reach a conclusion one way or other if signals do or do not provide controllability.

It is appreciated the intelligent controllability check process can utilize a variety of techniques for avoiding assignment values for the set of control signal inputs C. In one exemplary implementation, a modified intelligent QBF controllability check is utilized including a modified intelligent QBF solver. Additional information regarding a modified intelligent QBF controllability check is presented in following portions of the detailed description.

In block 150, an indication of a controllability analysis result for the control component under analysis is returned. In one embodiment, if assignments to control signal inputs C that cause s to be the target value of v (regardless of the other input values) are found, the results indicate that output signal s is controllable. In one embodiment, output signal s is a clamp signal or sleep signal.

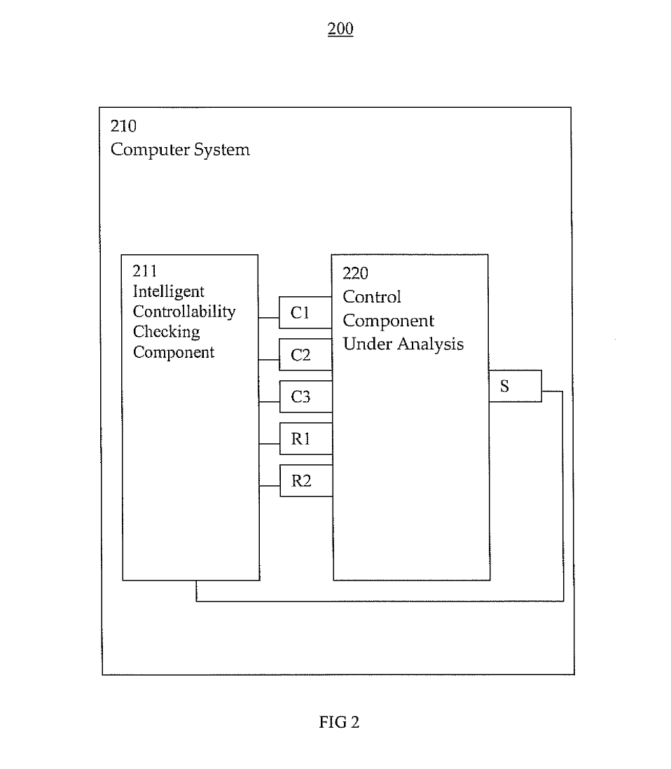

FIG. 2 is a block diagram of an exemplary intelligent controllability check system 200 in accordance with one embodiment of the present invention. Intelligent controllability test system 200 includes intelligent controllability checking component 211 on computer system 210 and control component under analysis 220 on computer system 210. It is appreciated that control component under analysis 220 can be a simulation implemented on computer system 210. Control component under analysis 220 can represent a power control component included in a very large hardware design (e.g., a power control unit in a very large scale integrated chip, a power control unit in a central processing unit, a power control unit in a graphics processing unit, etc.). The component under analysis 220 is checked or analyzed by intelligent controllability checking component 211.

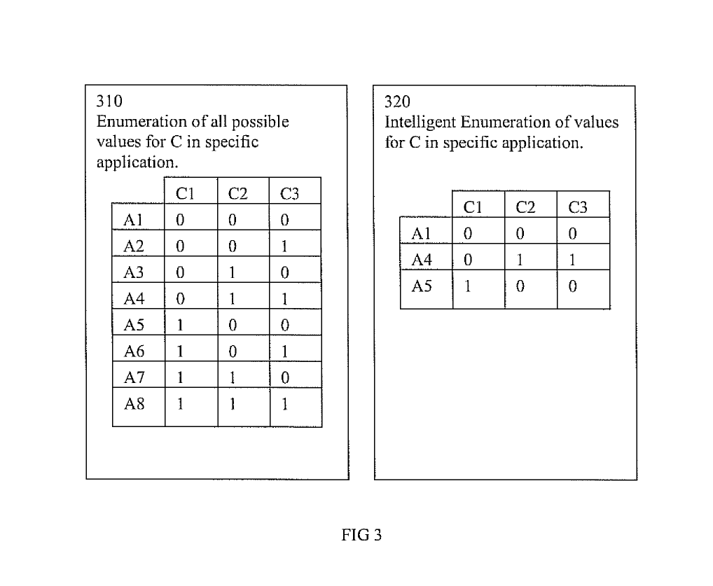

Controllability component under analysis 220 has a number of inputs including a set of control signal inputs C (e.g., C1, C2, C3) and other input signals (e.g., R1, and R2). Controllability component under analysis 220 also has an output signal s. In one embodiment, an intelligent controllability check involves the set of control signal inputs C (e.g., C1, C2, C3), a target value v for output signal s, and an equation defining control component under analysis 220 and output signal s. FIG. 3 is a block diagram of assignment scenarios for the set of signal inputs C. In assignment scenario 310, a set of all possible assignments (e.g., A1, A2, A3, etc.) of values for control signal inputs C are enumerated for the specific application. In assignment scenario 320, an intelligently selected set of assignments (A1, A4, and A5) of values for the control signal inputs C are enumerated for the specific application. The intelligently selected set of assignments of values for control signal inputs C includes less enumerated values than the set of all possible assignments (A1, A2, A3, etc.) of values for control signal inputs C. It is appreciated that the intelligently selected set of assignments of values for control signal inputs C can be developed or established utilizing a variety of techniques (e.g., QBF techniques, etc.). Additional information regarding a modified intelligent QBF controllability check is presented in following portions of the detailed description.

Intelligent controllability checking component 211 performs an intelligent controllability check. In one exemplary embodiment, the intelligent controllability check examines if assignments of values (e.g., logical values, signal values, etc.) to the set of control signal inputs C when applied to an equation defining the control component under analysis produces an output s with a target value of v (e.g., logical 1, logical 0, etc.) regardless of the values on other inputs (e.g., R1 and R2). The intelligent controllability check applies an intelligently enumerated set of assignments of values for the set of control signal inputs C. In one exemplary implementation, the intelligently enumerated set of assignments (A1, A4, and A5) are applied for analysis to the equation defining the control component under analysis 220. The analysis includes determining if an intelligently enumerated set of assignments include an assignment Av of values for the set of control signal inputs C that results in s being the particular target value v. The analysis is also capable of proving that such assignment Av of values does not exist.

It is appreciated that applying an intelligently enumerated set of assignments for analysis (e.g., to an equation defining the control component under analysis, etc.) results in less occupation of resources than applying all the potential enumerated assignments. It is also appreciated that if an intelligently enumerated set of assignments does not provide confirmation of controllability or lack of controllability, an intelligent controllability check can then optionally perform an analysis applying all the potential enumerated assignments. Additional information regarding different controllability checking approaches is presented in following portions of the detailed description.

In one embodiment, the intelligent controllability check conducts checks whether assignments of values to the set of control signal inputs C can set output signal s to two possible target logic values. It checks if one assignment (e.g., A1, etc.) of logic values to the set of control signal inputs C sets output signal s to a first logical value (e.g., logical value 1, false, etc.) regardless of other inputs (e.g., R1 and R2) to the control component under analysis 220. Then it checks if another assignment (e.g., A2) to the set of control signal inputs C sets output signal s to a second logical value (e.g., a logical value inverse of the first logical value, logical value 0, true, etc.) regardless of other inputs to the control component under analysis 220.

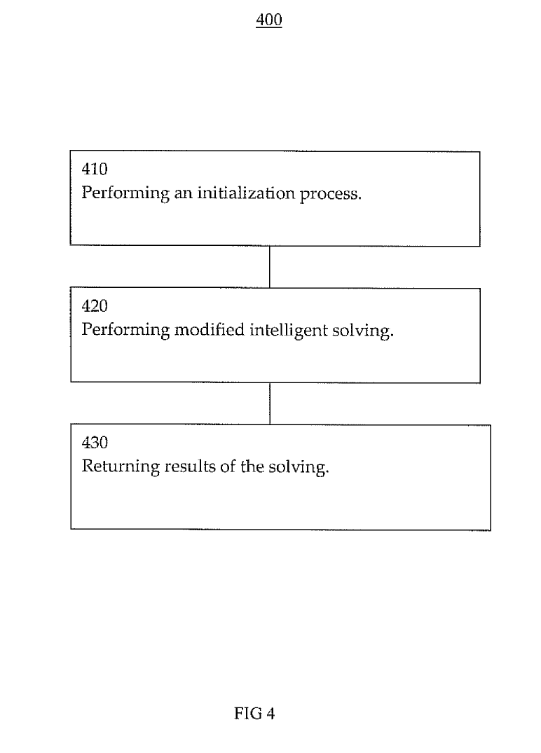

FIG. 4 is a flow chart of an exemplary intelligent controllability check process 400 in accordance with one embodiment of the present invention. In one embodiment, intelligent controllability check process 400 is similar to the intelligent controllability check process utilized in block 120.

In block 410, an initialization process is performed. In one embodiment, the values in a controllability environment format (e.g., a logic expression format, a format compatible with control component under analysis, etc.) are translated into a solver environment format (e.g., a format compatible with intelligent solver, etc.). In one exemplary implementation, the solver environment format includes a modified intelligent QBF-solver format (e.g., CNF format, Qdimacs, etc.). Additional information regarding an initialization process is presented in following portions of the detailed description.

In block 420, modified intelligent solving is performed. It is appreciated the intelligent controllability check process can utilize a variety of techniques. In one embodiment, modified intelligent QBF solving is performed. Additional information regarding modified intelligent solving is presented in following portions of the detailed description.

In block 430, the results of the solving are returned. The results can include an indication that an assignment Av of values to the set of control signal inputs C controls output signal s regardless of other inputs to the control component under analysis or inputs to the expression defining the control component under analysis. The results can include an indication that an assignment Av of values to control signal inputs C does not control the control component under analysis output s. In one embodiment, in which modified intelligent QBF solving is performed in block 420 the results can include SAT, UNSAT and ABORT indication. Unlike traditional approaches, the SAT indication can include additional information associated with the controllability checking. In one embodiment, the additional SAT indication information includes an assignment of C in the form of a list of corresponding pairs of a terminal of C and a value. In one exemplary implementation, the SAT indication includes a list of pairs of Cnf ids and values. Additional information regarding modified intelligent QBF controllability checking and solving is presented in following portions of the detailed description.

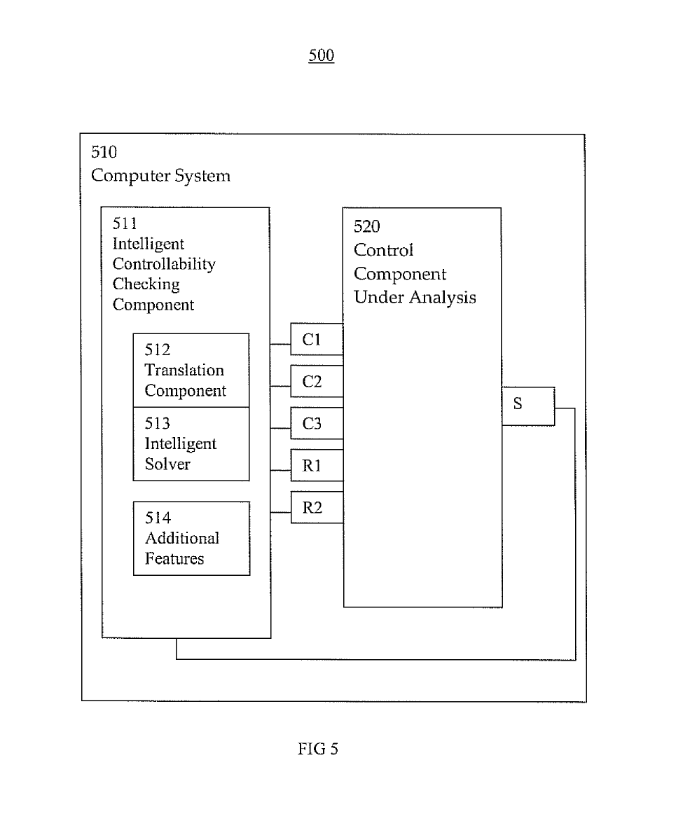

FIG. 5 is a block diagram of an exemplary intelligent controllability test system 500 in accordance with one embodiment of the present invention. Controllability test environment 500 is one embodiment of controllability test system 200. Controllability test environment 500 includes intelligent controllability checking component 511 implemented on computer system 510 and control component under analysis 520. It is appreciated control component under analysis 520 can be a simulation on computer system 510. Control component under analysis 520 is one embodiment of control component under analysis 220. Intelligent controllability checking component 511 is one embodiment of intelligent controllability checking component 211. Intelligent controllability checking component 511 includes translation component 512, intelligent solver 513, and additional features component 514.

The components of intelligent controllability test system 500 cooperatively operate to perform intelligent controllability checking. Intelligent controllability test system 500 performs various translations, including translation between different data structure formats (e.g., BED, CNF, etc.) and translation between non-Boolean and Boolean expressions (e.g., BIT-blast, etc.). In one embodiment, the values in a controllability environment format (e.g., a format compatible with control component under analysis 520, etc.) are translated by translation component 512 into a solver environment format (e.g., a format compatible with intelligent solver 513, etc.). Translation component 512 maps between each solver environment format value and corresponding control component under analysis interface values (e.g., the control signals values, rest signals values, etc.) and maintains a list of the mapping. In one embodiment, a translation component 512 translates between logic expressions and solver formats (e.g., BED format, CNF format, etc.). In one embodiment, intelligent solver 513 intelligently examines if an output signal s is controllable while efficiently avoiding possible but invalid assignments to control signal inputs C before enumerating and applying them to the inputs of the equation defining the control component under analysis that would otherwise occur in traditional approaches. In one exemplary implementation, if the results indicate that some assignment value enumerations can be avoided, additional processing time and resources are not expended analyzing those avoided assignments. Additional features component 514 can provide a variety of additional features (e.g., verification of results, alternative controllability checking approaches if the intelligent solver fails to conclude a signal is controllable, etc.).

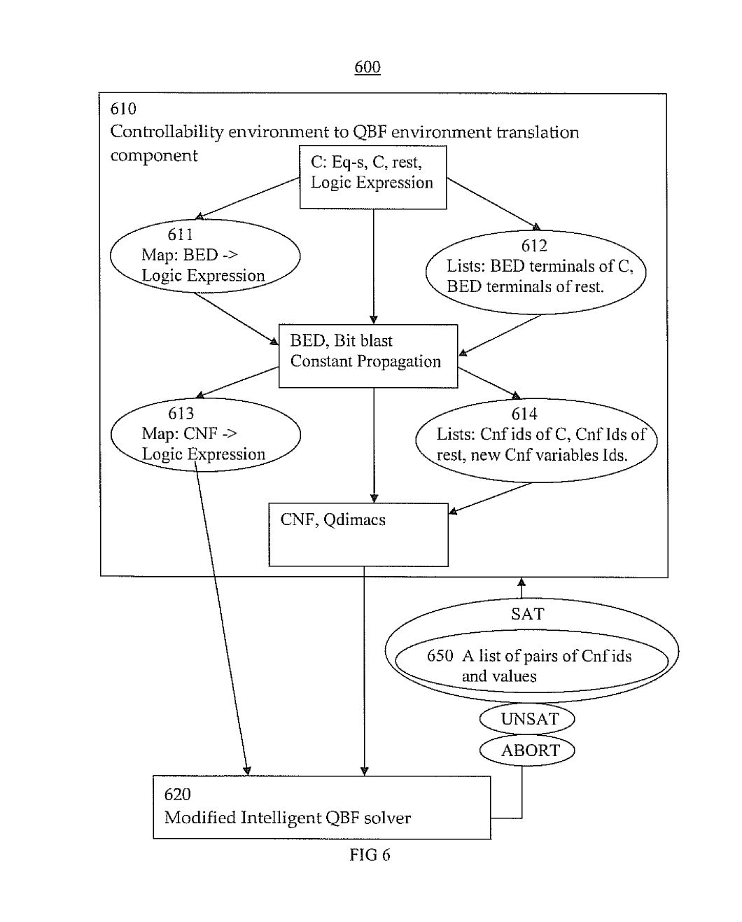

FIG. 6 is a block diagram of exemplary modified intelligent QBF controllability checking system 600 in accordance with one embodiment of the present invention. Controllability checking system 600 includes controllability environment/QBF environment translation component 610 and modified intelligent QBF solver 620. The components of modified intelligent QBF controllability checking system 600 cooperatively operate to perform modified intelligent QBF controllability checking.

Controllability environment/QBF environment translation component 610 translates between a controllability checking compatible format and a modified intelligent QBF compatible format. In one embodiment, controllability environment/QBF environment translation component 610 includes a Boolean Expression Diagram (BED)/logic expression map component 611 and a corresponding list component 612. QBF environment translation component 610 can also include a Conjunction Normal Form (CNF)/logic expression map component 613 and a corresponding list component 614.

In one embodiment, a modified intelligent QBF controllability check process translates a logic equation of an output signal s to cnf(s). During the translation it populates a map between cnf ids to each control signal input in a set of control signal inputs C. The set of cnf Ids representing the set of control signal inputs C is CcnfIds. In addition, it creates a list of cnf ids representing the rest of the inputs and keeps this list of cnfIds in incnfIds. It creates a cnf formula that represents s and keeps it in cnf(s). Finally, it keeps the new cnf variables in newcnfIds. Using these data it creates the following control component under analysis input formula or expression which is fed to the modified intelligent QBF solver:

[1] Exists CcnfIds, forall IncnfIds, Exists newcnfIds(cnf(s)).

The input formula [1], is a QBF SAT formula that is satisfied if and only if s is controllable. The reason is that every assignment that satisfies [1] demonstrates an assignment to the terminals in C that sets the signal s regardless of the values to the rest of the terminals.

Modified intelligent QBF solver component 620 intelligently determines a controllability assignment. In one embodiment, modified intelligent QBF component 620 intelligently avoids enumeration of some of the possible assignments from consideration that are irrelevant while performing efficient checking processing. The modified intelligent QBF solver can return a SAT indication, an UNSAT indication and an ABORT indication. An ABORT return means the solver run time exceeds the maximum time limit. An UNSAT return means there is no such assignment. A SAT return means the solver found an assignment. In one embodiment, the SAT indication includes an assignment of C in the form of a list of corresponding pairs of a terminal of C and a value. That assignment if applied to the terminal of C and evaluated by a constant propagation will set s regardless of any value of other inputs. In one exemplary implementation, the SAT indication includes a list 650 of pairs of Cnf ids and values. In one exemplary implementation, the solver is modified to return the assignments to CcnfIds. Then, using the maps 613, 611 this assignment is translated to terminals in C. In one embodiment, in a situation where the solver returns ABORT then a constant propagation controllability check is called. In a situation in which there is an UNSAT the solver indicates there is no such assignment. In one embodiment in which an UNSAT is returned there are two options. A first option is to conclude there is no such assignment, terminate the check at this point, and indicate the signal s is not controllable. A second option is to call a constant propagation controllability check in case there is a bug in the modified intelligent QBF-solver.

In one embodiment, modified intelligent QBF-Solvers can be utilized in the controllability checking. In one exemplary implementation, the solver's input file format is a Qdimacs which is similar to standard dimacs for CNF except it is preceded by alternative quantifiers. A new function called QBF controllability is implemented and uses a modified intelligent QBF-solver. In one embodiment, a modified intelligent QBF-SAT solver is utilized. In one exemplary implementation, the solution is complete and if given enough time returns a satisfying assignment Av (e.g., an assignment of values to the control signal inputs C that results in a target value v for output s, etc.) or a proof that such assignment cannot be found. While it can go over all possible assignments to control signal inputs C, it intelligently uses the latest SAT solving technology to perfume intelligent learning that enables it to skip many useless assignments. In one exemplary implementation, the assignment results of the modified intelligent QBF solver can be forwarded to a constant propagation verification process that is run on the assignment results from the modified intelligent QBF process but not other possibilities. In one embodiment, running the constant propagation verification process on the assignment results from the modified intelligent QBF process but not other possibilities is more efficient than traditional constant propagation attempts that check all possibilities. In one embodiment, if a modified intelligent QBF controllability check fails to conclude that output signal s is controllable, then there are two options. A first option is to conclude there is no such assignment, terminate the check at this point, and indicate the signal s is not controllable. A second option includes calling a function that uses constant propagation (e.g., const-controllability, etc.).

It is appreciated that an intelligent controllability check process can include a variety of controllability examination techniques. In one embodiment, one portion of an intelligent controllability check process includes a first examination technique and another portion includes a second examination technique. In one exemplary implementation, a first portion can be a first controllability check and a second portion can be utilized to verify results of the first controllability check. Additional information on additional or optional features (e.g., verification, alternate checking techniques, etc) is presented in following portions of the detailed description.

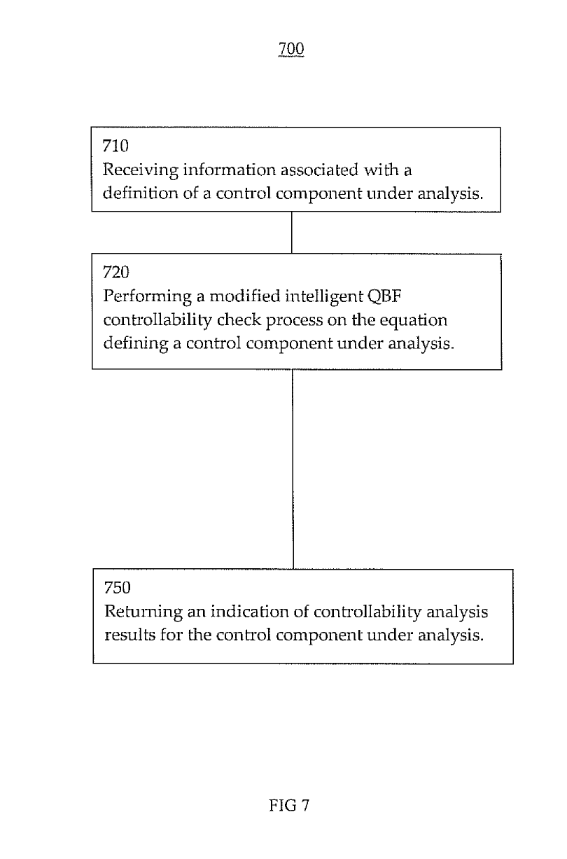

In one embodiment, an intelligent controllability check includes a modified intelligent QBF controllability check or examination technique. FIG. 7 is a flow chart of a modified intelligent QBF controllability check method 700 in accordance with one embodiment of the present invention. Modified intelligent QBF controllability check method 700 is similar to an embodiment of controllability check method 100 in which intelligent controllability check process 120 is a modified intelligent QBF controllability check process.

In block 710, information associated with a control component under analysis definition is received. Block 710 is one embodiment of block 110.

In block 720, a modified intelligent QBF controllability check process is performed on the equation defining the control component under analysis. Block 720 is one embodiment of block 120. In one embodiment, the modified intelligent QBF controllability check process includes modified intelligent QBF solving and translation between a controllability checking compatible format and modified intelligent QBF compatible format. In one exemplary implementation, modified intelligent QBF controllability check process 720 is implemented using modified intelligent QBF controllability checking system 600. In one embodiment, modified intelligent QBF controllability check process checks that an output signal s can be set to 1. Next, modified intelligent QBF controllability check process checks that an output signal s can be set to 0 by calling it after adding an inverter to the output signal s.

In one embodiment, the modified intelligent QBF controllability check process includes performing a formal controllability check that examines if enumeration of some possible value assignments for a set of control signal inputs (e.g., C, etc.) can be avoided (e.g., less than all the possibilities are enumerated, etc.). In one exemplary implementation, the modified intelligent QBF controllability check avoids enumerating some possible values for a set of control signal inputs that would otherwise occur in a traditional controllability check approach (e.g., avoid enumeration of values that a X propagation controllability check does not avoid, avoid enumeration of values that a constant propagation controllability check does not avoid, etc.). A modified intelligent QBF controllability check can include utilization of a modified intelligent QBF solver. In one embodiment, a modified intelligent QBF controllability check process includes a formal controllability check that comprises an extensive or exhaustive consideration of possible value assignments while avoiding enumeration of some possibilities. The formal controllability check can examines if a proof establishes a conclusion regarding assignment values (e.g., prove an input value exists that cause a output target value, prove no such input value exists, etc.). A modified intelligent QBF controllability check process can utilize the proof in determining possible results including: (1) a conclusion that signals provide controllability; (2) a conclusion that signals do not provide controllability; or (3) can not reach a conclusion one way or other if signals do or do not provide controllability. Additional information regarding a modified intelligent QBF controllability check is presented in following portions of the detailed description.

In block 750, an indication of controllability analysis results for the control component under analysis is returned. Block 750 is one embodiment of block 150.

It is appreciated, the performance of the modified intelligent QBF controllability check can have an input threshold or range. The modified intelligent QBF controllability check is not performed if the number of input is not within the threshold or range. In one exemplary implementation, the threshold or range includes 5-70 inputs. In one embodiment, an alternative or other controllability check (e.g., a constant propagation controllability check, a modified intelligent constant controllability check, an X propagation controllability check, etc.) can be performed if the number of inputs is not within the threshold or range.

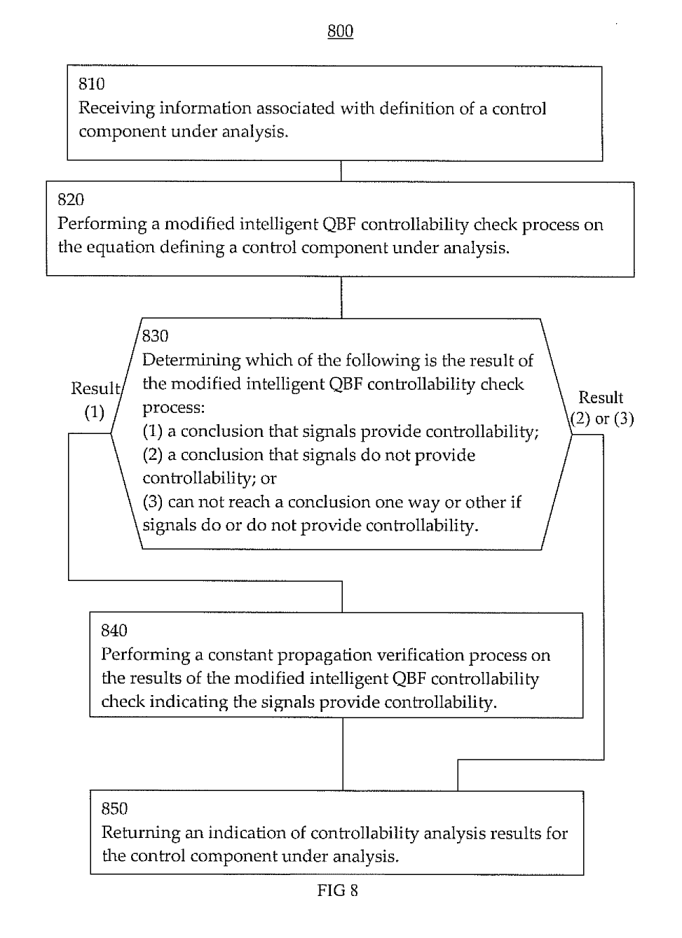

It is appreciated that an intelligent controllability check can include a verification process. In one exemplary implementation, one examination technique is utilized to check controllability and another examination technique is utilized to verify the results. FIG. 8 is a flow chart of controllability check method 800 in accordance with one embodiment of the present invention. Controllability check method 800 is similar to controllability check method 100 in which verification of the results of a modified intelligent QBF controllability check process is included when the modified intelligent QBF controllability check process results in a conclusion that an output signal s is controllable. In one embodiment in which a SAT is returned, the assignment can be utilized to set the values for a set of control signal inputs C, and then a constant propagation controllability verification method is called. This method propagates the constants on inputs C and performs other optimization that reduces the equations representing output signal s to a constant 1. This is used to verify that the assignment values received from the QBF-solver that sets output signal s to a target value v regardless of the other inputs. In one embodiment, a constant propagation controllability verification method is similar to a constant propagation controllability check except importantly the constant propagation controllability verification method checks the results of the modified intelligent QBF controllability check process and not all possible value assignments to the set of control signal inputs C.

In block 810, information associated with a control component under analysis definition is received. Block 810 is one embodiment of block 110.

Blocks 820, 830 and 840 are included in one embodiment of block 120.

In block 820, a modified intelligent QBF controllability check process is performed on the equation defining a control component under analysis.

In block 830, a determination is made regarding which of the following is the result of the modified intelligent QBF controllability check process from block 820: (1) a conclusion that signals provide controllability; (2) a conclusion that signals do not provide controllability; or (3) can not reach a conclusion one way or other if signals do or do not provide controllability. If the modified intelligent QBF controllability check process result includes (1) a conclusion that the signals provide controllability, the process proceeds to bock 840. If the modified intelligent QBF controllability check process result includes: (2) a conclusion that the signals do not provide controllability; or (3) can not reach a conclusion one way or other regarding whether the signals do or do not provide controllability, the process proceeds to block 850.

In block 840, a constant propagation controllability verification process is performed on the results of the modified intelligent QBF controllability check indicating the signals provide controllability. In one embodiment, the constant propagation controllability verification process verifies the signals and values that the modified intelligent QBF controllability check indicates provide controllability also provide controllability according to the constant propagation controllability verification. In one embodiment, the constant propagation controllability verification process efficiently verifies the results of the modified intelligent QBF controllability check indicating a signal provides controllability without wasting time on signals that do not provide controllability. In one exemplary implementation, the modified intelligent QBF controllability check allows the rapid and efficient identification of controllability while the constant propagation controllability verification process allows assurance the results are accurate.

It is appreciated that in many situations the results of the modified intelligent QBF controllability check significantly reduces the number of enumerated assignments input to the constant propagation controllability verification process as compared to a traditional constant propagation controllability check process. In one embodiment, the number of enumerated assignments input to the constant propagation controllability verification process is very small (e.g., 1, 2, 4, 10, etc.) as compared to a usual number of inputs to a traditional constant propagation controllability check (e.g., 100, 450, all possible inputs, etc.). In one exemplary implementation, the small number of enumerated inputs allows the constant propagation controllability verification process to provide the additional assurance and confidence of a verification at very little additional cost (e.g., time, occupying processing resources, power consumption, etc.)

In block 850, an indication of controllability analysis results for the control component under analysis is returned. Block 850 is one embodiment of block 150.

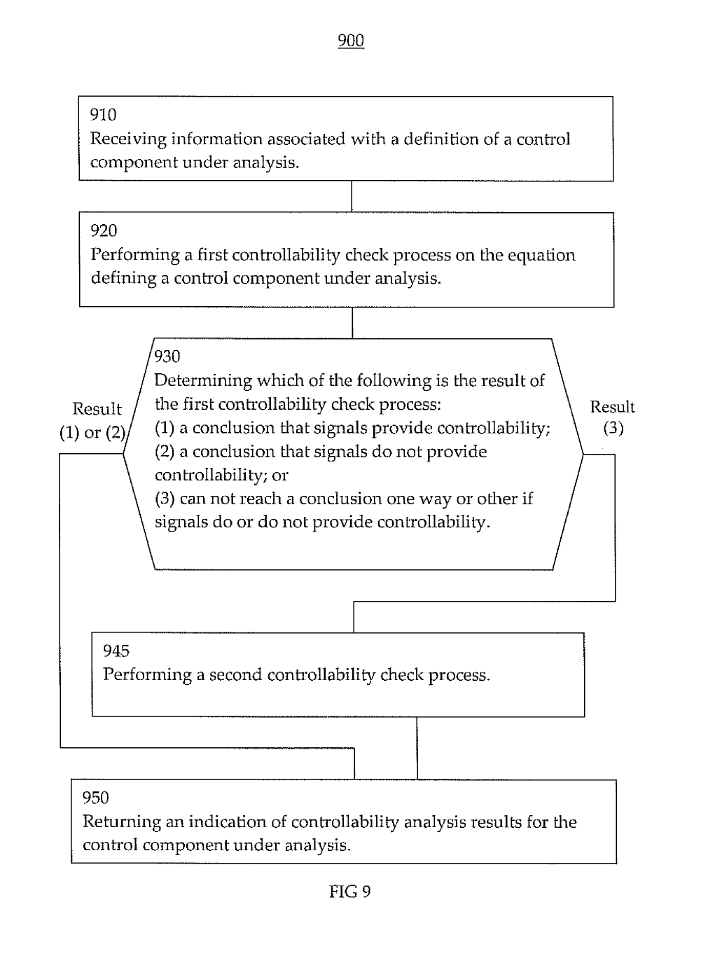

In one embodiment, an intelligent controllability check includes a fall-back checking process. In one exemplary implementation, if one examination technique is utilized but fails to provide adequate results another fall-back examination technique is utilized to provide results. FIG. 9 is a flow chart of controllability check method 900 in accordance with one embodiment of the present invention. Controllability check method 900 is similar to controllability check method 100 and includes a second or fall-back controllability check process if a first controllability check process can not reach a conclusion regarding the controllability of a signal.

In block 910, information associated with a control component under analysis definition is received. Block 910 is one embodiment of block 110.

Blocks 920, 930 and 945 are included in one embodiment of block 120.

In block 920, a first controllability check process is performed on the equation defining a control component under analysis. In one embodiment, the first controllability check process is considered a first level. In one exemplary implementation, the first controllability check process is faster (e.g., takes less time to reach a result, can reach a conclusion within limited time threshold, etc.) than a second controllability check process.

In block 930, a determination is made regarding which of the following is the result of the first controllability check process from block 920: (1) a conclusion that signals provide controllability; (2) a conclusion that signals do not provide controllability; or (3) can not reach a conclusion one way or other if signals do or do not provide controllability. If the first controllability check process result includes: (1) a conclusion that the signals provide controllability; or (2) a conclusion that the signals do not provide controllability, the process proceeds to block 950. If the first controllability check process results is (3) and can not reach a conclusion one way or other regarding whether the signals do or do not provide controllability, the process proceeds to block 945. In one embodiment, if there is an indication that a first controllability check process is aborted, a second controllability check process can be performed.

In one exemplary implementation, the first controllability check process has a predetermined time limit constraint. If the time limit constraint expires or is exceeded before block 930 is complete the process can proceed to block 940

In block 945, a second controllability check process is performed if the first controllability check can not reach a conclusion one way or other regarding whether the signals do or do not provide controllability. In one embodiment, the second controllability check process is considered a second level. In one exemplary implementation, the second controllability check process is slower (e.g., takes more time to reach a result, can reach a conclusion within larger time threshold, no time threshold, etc.) than a first controllability check process. It is appreciated the first controllability check process and second controllability check process can be different.

In block 950, an indication of controllability analysis results for the control component under analysis is returned. Block 950 is one embodiment of block 150.

In one exemplary implementation, having the second controllability check provides a “safety” or fall-back check. The second controllability check can provide a fall back check if a first controllability check can not reach a conclusion that signals are controllable or a conclusion that the signals are not controllable.

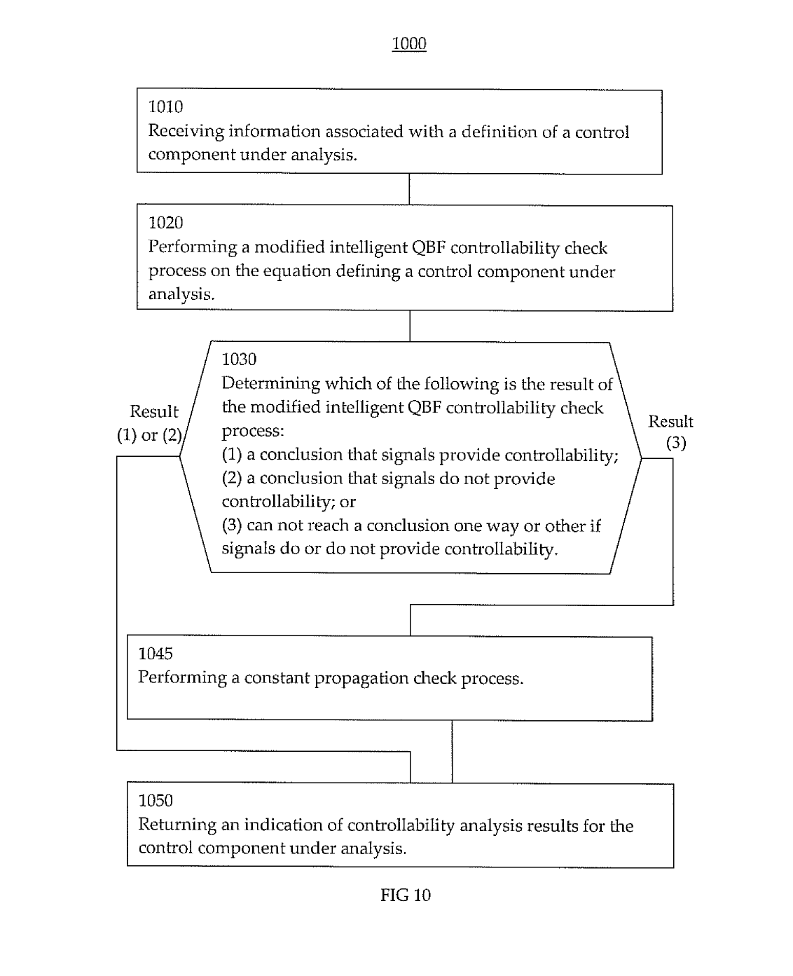

FIG. 10 is a flow chart of controllability check method 1000 in accordance with one embodiment of the present invention. Controllability check method 1000 is similar to controllability check method 100 and a constant propagation controllability check process is included if a modified intelligent QBF controllability check process can not reach a conclusion that the signals are controllable or are not controllable. In one embodiment, controllability check method 1000 is similar to controllability check method 900 in which the first level is a modified intelligent QBF controllability check process and the second level is a constant propagation controllability check. In one exemplary implementation, if a first level modified intelligent QBF controllability check process is aborted a constant propagation check process is performed.

In block 1010, information associated with a control component under analysis definition is received. Block 1010 is one embodiment of block 110.

Blocks 1020, 1030 and 1045 are included in one embodiment of block 120.

In block 1020, a modified intelligent QBF controllability check process is performed on the equation defining the control component under analysis. In one embodiment, modified intelligent QBF controllability check process includes modified intelligent QBF solving and translation between a controllability checking compatible format and modified intelligent QBF compatible format. In one exemplary implementation, modified intelligent QBF controllability check process 1020 is implemented using modified intelligent QBF controllability checking system 600.

In block 1030, a determination is made regarding which of the following is the result of the modified intelligent QBF controllability check process from block 1020: (1) a conclusion that signals provide controllability; (2) a conclusion that signals do not provide controllability; or (3) can not reach a conclusion one way or other if signals do or do not provide controllability. If the modified intelligent QBF controllability check process result includes: (1) a conclusion that the signals provide controllability; or (2) a conclusion that the signals do not provide controllability, the process proceeds to block 1050. If the modified intelligent QBF controllability check process result is (3) and can not reach a conclusion one way or other if signals do or do not provide controllability, the process proceeds to block 1045.

In block 1045, a constant propagation controllability check process is performed. In one embodiment, the constant propagation controllability check process performs a controllability check on all the signals. Even though the constant propagation controllability check process performs a controllability check on all the signals when the modified intelligent QBF controllability check can not reach a conclusion that the signals are controllable or are not controllable, controllability check method 1000 is on average still more efficient than conventional approaches since the constant propagation controllability check is not performed when the modified intelligent QBF controllability check results in a conclusion that the signals are controllable or results in a conclusion that the signals are not controllable. The resulting efficiency savings when the QBF controllability check results in a conclusion that the signals are controllable on average outweighs the few occasions in which the constant propagation controllability check process is performed. In one exemplary implementation, having the constant propagation controllability check provides an alternative check if the modified intelligent QBF controllability check was not conclusive.

In block 1050, an indication of controllability analysis results for the control component under analysis is returned. Block 1050 is one embodiment of block 150.

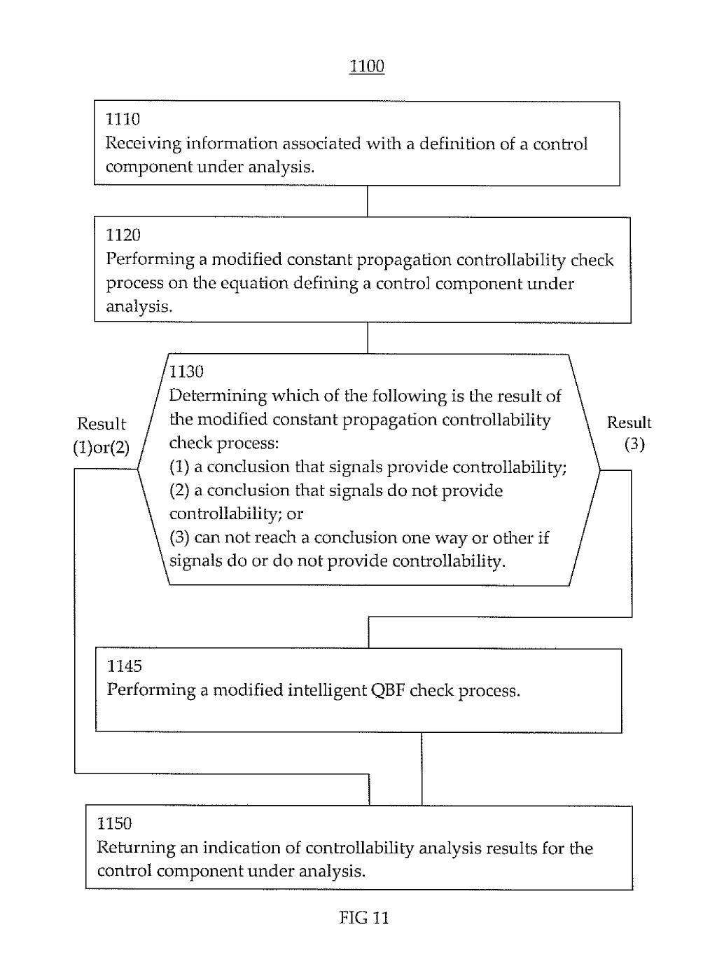

FIG. 11 is a flow chart of controllability check method 1100 in accordance with one embodiment of the present invention. Controllability check method 1100 is similar to controllability check method 100 in which a modified constant propagation controllability check process and a modified intelligent QBF controllability check process are included, wherein the modified intelligent QBF controllability check process is performed if the modified constant propagation controllability check process results in a conclusion that the signals do not provide controllability or can not reach a conclusion one way or other if signals do or do not provide controllability. In one embodiment, controllability check method 1100 is similar to controllability check method 900 in which the first level is a modified constant propagation controllability check process and the second level is a modified intelligent QBF controllability check process.

In block 1110, information associated with a control component under analysis definition is received. Block 1110 is one embodiment of block 110.

Blocks 1120, 1130 and 1145 are included in one embodiment of block 120.

In block 1120, a modified constant propagation controllability check process is performed on the equation defining the control component under analysis. In one embodiment, the modified constant propagation controllability check process performs a constant propagation controllability check on less than all the possible assignments of values to the control signal inputs C. In one exemplary implementation, the constant propagation controllability check is performed on a subset of all possible assignments. It is appreciated the subset can have a number of values or configurations. The subset of assignments can be special patterns (e.g., 000, 001, 101, 111, etc.) forced on the inputs. The subset can be a limited number of random values selected from the set of all possible assignment values.

In block 1130, a determination is made regarding which of the following is the result of the modified constant propagation controllability check process from block 1120: (1) a conclusion that signals provide controllability; (2) a conclusion that signals do not provide controllability; or (3) can not reach a conclusion one way or other if signals do or do not provide controllability. If the modified constant propagation controllability check process result includes: (1) a conclusion that the signals provide controllability; or (2) a conclusion that the signals do not provide controllability, the process proceeds to block 1150. If the modified constant propagation controllability check process result includes (3) can not reach a conclusion one way or other if signals do or do not provide controllability, the process proceeds to block 1145.

In block 1145, a modified intelligent QBF controllability check process is performed. In one embodiment, the modified intelligent QBF controllability check process is similar to block 820. It is also appreciated that a determination (not shown) can be included in process 1100 similar to a determination of block 830.

In block 1150, an indication of controllability analysis results for the control component under analysis is returned. Block 1150 is one embodiment of block 150.

While it is not shown, it is appreciated that there can be more than two levels of controllability checks. In one embodiment, another constant controllability check process similar to constant controllability check process 1045 can be added after modified intelligent QBF controllability check process 1145 to catch inconclusive results of the modified intelligent QBF controllability check process 1145. It is appreciated there can be a variety of configurations or options implemented. In one embodiment, an intelligent controllability check includes both a verification process and a fall-back checking process.

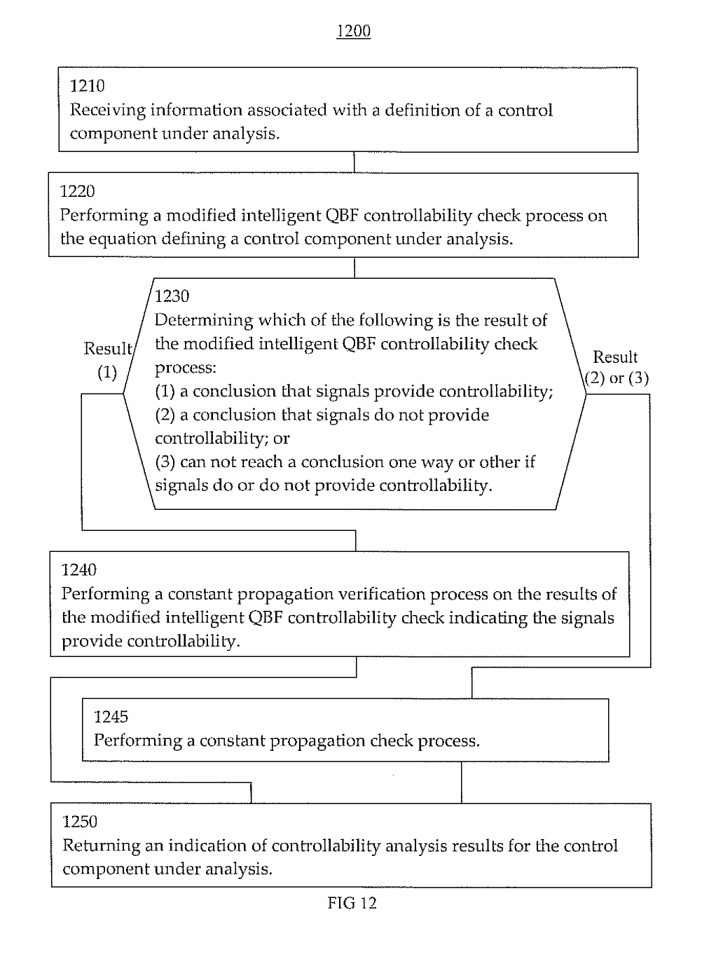

FIG. 12 is a flow chart of controllability check method 1200 in accordance with one embodiment of the present invention. Controllability check method 1200 is similar to controllability check method 100 in which a verification of the results of the modified intelligent QBF controllability check process is performed when the modified intelligent QBF controllability check process results in a conclusion that the signals are controllable and a constant propagation controllability check process is performed if the modified intelligent QBF controllability check process results in a conclusion that the signals do not provide controllability, or can not reach a conclusion one way or other if signals do or do not provide controllability. In one exemplary implementation, aspects of the modified intelligent QBF controllability check (e.g., QBF heuristics, applicability of a particular QBF algorithm to a particular application, translation from netlist to QBF format, etc,) give rise to a desire to perform a verification of the modified intelligent QBF controllability check.

In block 1210, information associated with a control component under analysis definition is received. Block 1210 is one embodiment of block 110.

Blocks 1220, 1230, 1240 and 1245 are included in one embodiment of block 120.

In block 1220, a modified intelligent QBF controllability check process is performed on the equation defining the control component under analysis. In one embodiment, a modified intelligent QBF controllability check process includes modified intelligent QBF solving and translation between a controllability checking compatible format and modified intelligent QBF compatible format. In one exemplary implementation, modified intelligent QBF controllability check process 1220 is implemented using intelligent QBF controllability checking system 600.

In block 1230, a determination is made regarding which of the following is the result of the modified intelligent QBF controllability check process from block 1220: (1) a conclusion that signals provide controllability; (2) a conclusion that signals do not provide controllability; or (3) can not reach a conclusion one way or other if signals do or do not provide controllability. If the modified intelligent QBF controllability check process result includes (1) a conclusion that the signals provide controllability, the process proceeds to block 1240. If the modified intelligent QBF controllability check process result includes (2) a conclusion that the signals do not provide controllability, or (3) can not reach a conclusion one way or other if signals do or do not provide controllability, the process proceeds to block 1245.

In block 1240, a constant propagation controllability verification process is performed on the results of the modified intelligent QBF controllability check indicating the signals provide controllability. In one embodiment, the constant propagation controllability verification process of block 1240 is similar to the constant propagation controllability verification process of block 840.

In block 1245, a constant propagation controllability check process is performed. In one embodiment, a constant propagation controllability check process of block 1245 is similar to a constant propagation controllability check process of block 1045.

In block 1250, an indication of controllability analysis results for the control component under analysis is returned. Block 1250 is one embodiment of block 150.

It is appreciated that increased efficiency over conventional approaches can be realized by the presented multi-level checking. In one embodiment, the savings in time and resource occupation by relatively rapid conclusions regarding controllability at a first level of control checking on average can outweigh time and resource occupation in instances where a conclusion can not be reached until a second level analysis of control checking is performed. In one exemplary implementation, efficiency in instances where a modified intelligent QBF controllability check at a first level reaches a conclusion regarding controllability without enumerating all possible assignment values for control signal inputs C on average outweighs instances in which a second level constant propagation checking in which all possible assignment values for control signal inputs are enumerated and used to reach a conclusion on controllability.

It is appreciated that a variety of different modified intelligent QBF controllability check processes can be implemented. The different modified intelligent QBF controllability check processes can include different heuristics or be directed to different problems. In one embodiment, a first modified intelligent QBF controllability check processes is directed or tuned to a first problem or application (e.g., hardware verification problem, CAD specific problem, etc.) and a second modified intelligent QBF controllability check processes is directed or tuned to a second problem (e.g., a general problem, an artificial intelligence problem, a random problem, etc.). In one embodiment, the utilization of a constant propagation controllability verification process and a constant propagation controllability check process can be based upon the trust or confidence level in the accuracy and applicability of a particular QBF controllability check process.

In one embodiment, the tests or checks include a few dozen to over a thousand signals involved in the controllability check. The check of each one of these signals can be independent. Therefore, the tests or checks can be run in parallel. In one exemplary implementation, the old method and the new method are run on a single machine for comparison. The results of a parallel run can be much faster.

Unlike traditional approaches that only validate if the conclusion is UNSAT (e.g., conventional techniques that include recoding antecedents for conflicts and assignments, constructing a resolution based proof by a post-root DFS, etc.); presented intelligent controllability checks approaches (e.g., method 100, 700, 800, system 200, etc.) can validate both a conclusion that signals are controllable (e.g., SAT, etc.) and a conclusion that signals are not controllable (e.g., UNSAT, etc.) can be validated. In one exemplary implementation, more than just pass fail is utilized by the solver to validate the solver. In one embodiment, the solver provides the assignment it finds for the outmost existential variables. Most DPLL solvers keep this assignment and therefore it is available for utilization. In one embodiment, a presented controllability check doesn't require any recoding of information, which saves memory and speedup runtime. In one exemplary implementation the proof is done by a constant propagation and optimization process which is a very fast and efficient process.

A constant propagation check process can include a random approach to assignment for controllability checking and the advantages of an intelligent modified QBF controllability check (e.g., intelligently avoiding enumeration of some possible values, etc.) are more efficient on average over various constant propagation approaches of enumerating more values and randomly checking assignments. In one embodiment, there can be an upper limit or threshold on the number of module inputs (e.g., up to 2⁴², 2⁶⁵, etc.) where efficiencies of a modified intelligent QBF controllability check process over a constant propagation check process diminish. A constant propagation check process random approach to assignment can have a chance of reaching a controllability conclusion “randomly” and may be efficient compared to a modified intelligent QBF controllability check when the number of module inputs exceeds the upper limit or threshold. In one exemplary implementation, when a number of inputs is at or below a threshold a modified intelligent QBF controllability check process is utilized and when the number of inputs is above a threshold a constant propagation check process is utilized.

In one embodiment, there are two behaviors associated with the presented modified intelligent QBF controllability check approaches. The first behavior is utilization of a modified intelligent QBF-SAT solver. In one exemplary implementation, the use of a modified intelligent QBF-SAT solver can be identified by the unique input file that it uses. Unlike a standard sat-solver that uses dimacs format, a modified intelligent QBF-SAT solver uses Qdimacs that have unique data fields at the top of the file. The second behavior is a unique modification made to the QBF-SAT solver. The modification enhances the solver to return the relevant part of the assignment it found. Most QBF-solvers won't return the full assignment because it is impractical. Returning only the part needed for this innovation is a characteristic of the presented modified intelligent QBF controllability check approach.

In one exemplary implementation, the present intelligent controllability checking approach advantage is demonstrated by choosing a simple parametric benchmark, bench(n) where n defines the complexity and changes from 1 to 14. A benchmark that has an AND gate like the one discussed (with an input and its negation) is chosen. Therefore, the X propagation won't be able to solve it. In addition, the benchmark is chosen to have increasingly more combinations to go through such that the constant evaluation will take more and more time. Finally, many XOR gates are used in order to challenge the sat solver a little bit.

The following is one exemplary expression or definition of Bench (1):

Inputs: in1, in2 . . . in10, c1, c2, c3.

Outputs: k1_{—}0,k1_{—}1,s1

K1_{—}0=!c2

K1_{—}1=c1&c3

S1=(k1_{—}1|(in1̂in2̂ . . . in10̂c3)) & k1_{—}0|(in1 & !in1)

The following is one exemplary expression or definition of Bench (i+1):

Inputs: in1, in2 . . . in10, c1, c2, c3, . . . c{i*2}, c{i*2+1}.

Outputs: k1_{—}0,k1_{—}1,s1

Ki_{—}0=!c2&!c4& . . . & !c{i*2}

Ki_{—}1=c1&c3& . . . & c{i*2+1}

Si=(ki_{—}1|(in1̂in2̂ . . . in10̂c3̂ . . . ̂c{i*2+1})) & ki_{—}0|(in1 & !in1)

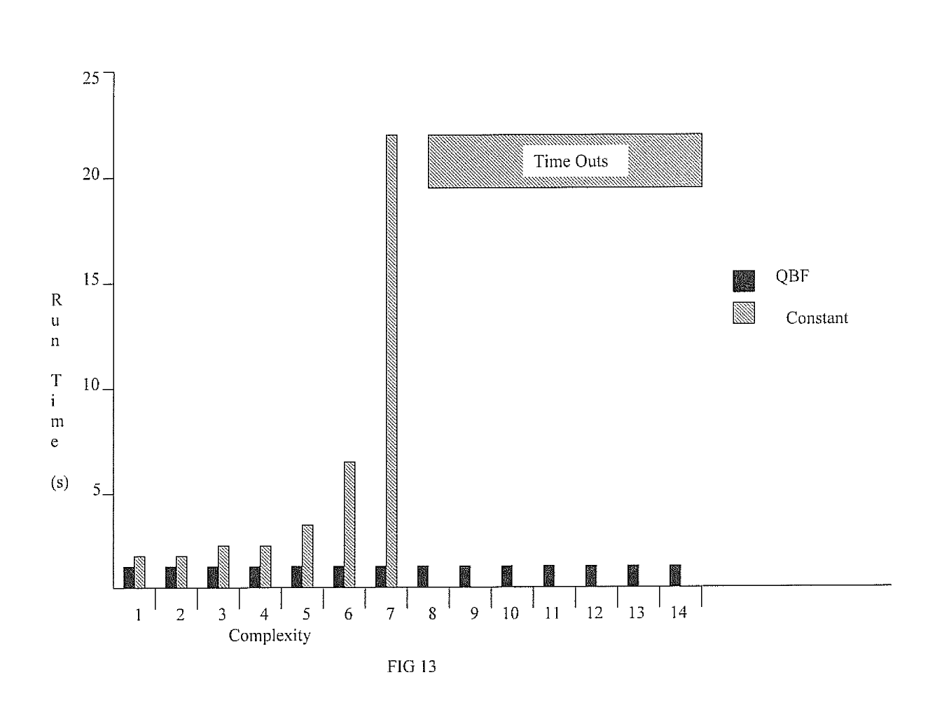

FIG. 13 is a table or graph of exemplary run time versus complexity results in accordance with one embodiment of the present invention. The results of the different run times versus complexities can be analyzed and compared. This analysis and comparison can show that despite the conditions outlined above the presented modified intelligent QBF approach runtime increases linearly while a constant propagation approach increases exponentially. In one embodiment, the results show that while the complexity of the benchmark increases according to n, the runtime increases linearly. This linear increase is despite of the exponential increase in the number of combinations that need to be checked.

It is appreciated that presented modified intelligent QBF controllability check systems and methods can be included in a variety of environments. While the description of presented modified intelligent QBF controllability check systems and methods is often discussed in terms of power controllability and management, it is appreciated the presented modified intelligent QBF controllability check can be utilized for a variety of controllability checks (e.g., communication, processing, etc.). In one embodiment, the power controllability and management can be utilized in a manufacturing or fabrication environment (e.g., for floor sweeping, for testing, etc.).

Thus, presented approaches facilitate efficient controllability checking. Conventional approaches often attempt checks or analysis of all possible Boolean assignments to the inputs of a component under analysis and may cause the runtime to be prohibitively large (e.g., of the order of few days, etc.). In one embodiment, the presented modified intelligent QBF controllability check approach describes a new algorithm that is based on a modified QBF-SAT solver that skips many useless assignments. The presented modified intelligent QBF controllability check approach runtime can be a fraction of the conventional constant propagation check time (of the order of a few minutes). The presented approaches can facilitate efficient controllability check of a power gated control module.

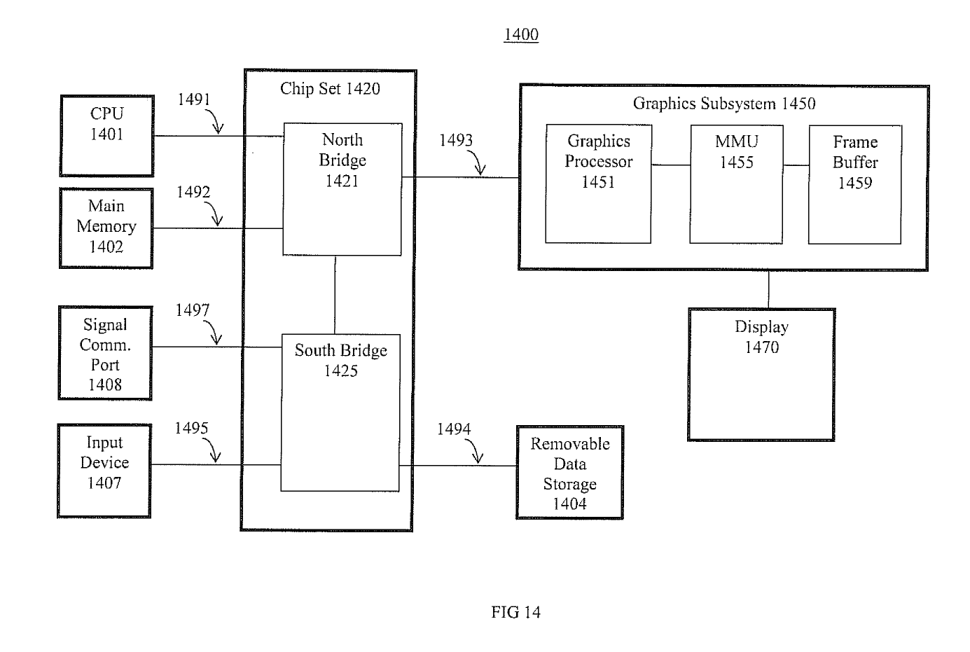

FIG. 14 is a block diagram of a computer system 1400, one embodiment of a computer system upon which embodiments of the present invention can be implemented. Computer system 1400 includes central processor unit 1401, main memory 1402 (e.g., random access memory), chip set 1420 with north bridge 1421 and south bridge 1425, removable data storage device 1404, input device 1407, signal communications port 1408, and graphics subsystem 1450 which is coupled to display 1470. Computer system 1440 includes several busses for communicatively coupling the components of computer system 1400. Communication bus 1491 (e.g., a front side bus) couples north bridge 1421 of chipset 1420 to central processor unit 1401. Communication bus 1492 (e.g., a main memory bus) couples north bridge 1421 of chipset 1420 to main memory 1402. Communication bus 1493 (e.g., the Advanced Graphics Port interface) couples north bridge of chipset 1420 to graphic subsystem 1450. Communication buses 1494-1497 (e.g., a PCI bus) couple south bridge 1425 of chip set 1420 to removable data storage device 1404, input device 1407, signal communications port 1408 respectively. Graphics subsystem 1450 includes graphics processor 1451, memory management unit 1455 and graphics buffer 1459.

The components of computer system 1400 cooperatively operate to perform a variety of processing tasks and facilitate efficient memory accesses. Communications bus 1491, 1492, 1493, 1494, 1495 and 1497 communicate information. Central processor 1401 processes information. Main memory 1402 stores information and instructions for the central processor 1401. Removable data storage device 1404 also stores information and instructions (e.g., functioning as a large information reservoir). Input device 1407 provides a mechanism for inputting information and/or for pointing to or highlighting information on display 1470. Signal communication port 1408 provides a communication interface to exterior devices (e.g., an interface with a network). Display device 1470 displays information in accordance with data stored in frame buffer 1459. Graphics processor 1451 processes graphics commands from central processor 1401 and provides the resulting data to graphics buffers 1459 for storage and retrieval by display monitor 1470. Memory management unit 1455 handles the memory access requests between graphics processor 1451 and graphics buffers 1459. It is appreciated that similar memory management units can be implemented to facilitate efficient and independent access requests to other memory components of computer system 1400, including main memory 1402 and bulk data storage 1404.

It is appreciated that the present invention can be implemented in a variety of embodiments. In one exemplary implementation the present invention can be utilized for controllability checking of processing systems utilized to provide a variety of graphics applications including video games. For example, the present invention can be utilized for controllability checking in a game console, personal computer, personal digital assistant, cell phone or any number of platforms for implementing a video game. It is also appreciated that references to video game application implementations are exemplary and the present invention is not limited to these implementations.

Portions of the detailed description are presented and discussed in terms of a method. Although steps and sequencing thereof are disclosed in figures herein describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed within a computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps include physical manipulations of physical quantities. Usually, though not necessarily, these quantities take the form of electrical, magnetic, optical or quantum signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “processing”, “computing”, “calculating”, “determining”, “displaying”, “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Some embodiments may be described in the general context of computer-executable instructions, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A controllability check method comprising:
receiving information associated with a definition of a control component under analysis, including an equation defining the control component under analysis;
performing an intelligent controllability check process based upon the received information, including performing a formal controllability check examines if enumeration of some possible values for a set of control signal inputs can be avoided; and
returning an indication of controllability analysis results for the control component under analysis.

2. The controllability check method of claim 1 wherein the intelligent controllability process includes:
performing an initialization process, including translating values in a controllability environment format into a solver environment format;
performing modified intelligent QBF solving; and
returning the results of the solving.

3. The controllability check method of claim 2 wherein the intelligent controllability process includes:
mapping between each solver environment format value and corresponding control component under analysis interface value; and
maintaining a list of the mapping.

4. The controllability check method of claim 2 wherein the results of the QBF solving includes one of the three possible values:
ABORT meaning the solver run time exceeds the maximum time limit;
UNSAT meaning the solver found there is no such assignment; and
SAT meaning the solver found an assignment.

5. The controllability check method of claim 2 wherein the intelligent controllability check process is looking for an assignment A to the set C that has the following properties:
applying A to C results in the output of the equation defining the control component under analysis being a target value regardless of the other inputs values; and
providing the values for the above A if it exists and alternatively proving that such A does not exist.

6. The controllability check method of claim 1 wherein the intelligent controllability process includes:
performing a first controllability checking technique, wherein the first controllability checking technique has a predetermined time limit constraint; and
performing a second controllability checking technique if the result of the first controllability checking technique can not reach a conclusion one way or other if signals do or do not provide controllability.

7. The controllability check method of claim 1 wherein the intelligent controllability process includes verification of the results.

8. An intelligent controllability check system comprising:
a control component under analysis;
an intelligent controllability checking component operable to perform an intelligent controllability check for the control component under analysis, including performing a formal controllability check that examines if enumeration of some possible values for a set of control signal inputs can be avoided.

9. The intelligent controllability check system of claim 8 the control component under analysis is included in a very large hardware design.

10. The intelligent controllability check system of claim 8 wherein the intelligently enumerated assignment of values for control signal inputs are established utilizing a modified intelligent QBF process.

11. The intelligent controllability check system of claim 8 wherein the intelligent controllability checking component examines if assignment of values to control signal inputs when applied to an equation defining the control component under analysis produces an output with a target value regardless of the values on other inputs.

12. The intelligent controllability check system of claim 8 wherein the intelligent controllability checking component includes a translation component operable to: map between a solver environment format value and corresponding control component under analysis interface value, and maintain a list of the mapping.

13. The intelligent controllability check system of claim 8 wherein the intelligent controllability checking component includes a controllability environment/QBF environment translation component operable to translate between a controllability checking compatible format and a modified intelligent QBF compatible format.

14. The intelligent controllability check system of claim 8 wherein the intelligent controllability checking component includes a modified intelligent QBF component operable to intelligently avoid enumerating some of the possible assignments that are irrelevant while performing efficient checking.

15. A system including a processor and a memory for storing instructions which direct the processor in performance of a controllability check method comprising:
receiving information associated with a definition of a control component under analysis, including an equation defining the control component under analysis;
performing an intelligent controllability check process based upon the received information, including performing a formal controllability check that examines if enumeration of some possible values for a set of control signal inputs can be avoided; and
returning an indication of controllability analysis results for the control component under analysis.

16. The controllability check system of claim 15 wherein the intelligent controllability process includes performing a modified intelligent QBF controllability check; and the modified intelligent QBF controllability check avoids enumerating some possible values for a set of control signal inputs that a X propagation controllability check and constant propagation controllability check do not avoid.

17. The controllability check system of claim 15 wherein the intelligent controllability process includes:
mapping between each solver environment format value and corresponding control component under analysis interface values; and
maintaining a list of the mapping.

18. The controllability check system of claim 15 wherein the intelligent controllability check process is looking for an assignment A to the set C that has the following properties:
applying A to C results in the output of the equation defining the control component under analysis being a target value regardless of the other inputs values; and
providing the values for the above A if it exists and alternatively proving that such A does not exist, even if the number of inputs is very large.

19. The controllability check system of claim 15 wherein the intelligent controllability process includes:
performing a first controllability checking technique; and
performing a second controllability checking technique if the first controllability checking technique first controllability checking technique can not reach a conclusion one way or other if signals do or do not provide controllability.

20. The controllability check system of claim 15 wherein the intelligent controllability process includes verification of the results, wherein the verification can be based upon a level of trust in a modified intelligent QBF controllability check and the verifying can include both SAT and UNSAT.
